(19) United States
(12) Patent Application Publication
(10) Pub. No.: US 2003/0026533 A1
(43) Pub. Date: Feb. 6, 2003

(54) Configurable dispersion management device

(76) Inventors: Yochay Danziger, Dallas, TX (US); Yongqian Liu, Richardson, TX (US)

Correspondence Address: LASERCOMM, INC., INTELLECTUAL PROPERTY DEPT., 2600 TECHNOLOGY DRIVE SUITE 900, PLANO, TX, 75074, US

(21) Appl. No.: 10/200,742

(22) Filed: Jul. 24, 2002

Related U.S. Application Data
(60) Provisional application No. 60/309,498, filed on Aug. 3, 2001.
(60) Provisional application No. 60/364,082, filed on Mar. 15, 2002.

(51) Int. Cl. G02B 6/26

(52) U.S. Cl. 385/27; 385/28

(57) ABSTRACT

A configurable dispersion compensating device for compensating for both the dispersion and slope of an attached optical communication span comprising at least one mode transformer and an optional fixed trim fiber. Additional trim fibers are switched into the optical path as required in order to maintain a dispersion and dispersion slope target for each span and for the overall optical communication link. In one embodiment the trim fiber comprises standard single mode fiber, while in another embodiment a slope correcting trim fiber is utilized. Optionally, attenuators are switched in place of unused trim fiber to maintain a fixed insertion loss. Switches may comprise patch cords or optical switches which may be manually operated or operated from a remote network management station.

### CROSS-REFERENCE TO RELATED APPLICATIONS

The present application claims the benefit of the filing date of copending U.S. provisional application, Ser. No. 60/309,498 filed Aug. 3, 2001, entitled “CONFIGURABLE DISPERSION MANAGEMENT DEVICE” and incorporates by reference co-pending U.S. patent application Ser. No. 09/860,647 filed May 21, 2001 entitled “METHOD AND SYSTEM FOR COMPENSATING FOR CHROMATIC DISPERSION” and co-pending U.S. Provisional Application Ser. No. 60/364,082 filed Mar. 15, 2002 entitled “TRIM FIBER FOR HIGH ORDER MODE APPLICATIONS”.

### BACKGROUND OF THE INVENTION

The invention relates generally to the field of optical transmission systems, and more specifically to configurable dispersion compensation in optical transmission systems.

Optical fiber has become increasingly important in many applications involving the transmission of light. When a pulse of light is transmitted through an optical fiber, the energy follows a number of paths which are called modes. A mode is a spatially invariant electric field distribution along the length of the fiber. The fundamental mode, also known as the LP₀₁ mode, is the mode in which light passes substantially along the fiber axis. Modes other than the LP₀₁ mode, are known as high order modes. Fibers which have been designed to support only one mode with minimal loss, the LP₀₁ mode, are known as single mode fibers. A multi-mode fiber is a fiber whose design supports multiple modes, and typically supports over 100 modes. A few-mode fiber is a fiber designed to support only a very limited number of modes. For the purpose of this patent, we will define a few mode fiber as a fiber supporting no more than 20 modes at the operating wavelength. Fibers may carry different numbers of modes at different wavelengths, however in telecommunications the typical wavelengths are near 1310 nm and 1550 nm.

As light traverses the optical fiber, different group of wavelengths travel at different speeds, which leads to chromatic dispersion. Chromatic dispersion is defined as the differential of the group velocity in relation to the wavelength in units of picosecond/nanometer (ps/nm). Optical fibers are often characterized by their dispersion per unit length of 1 kilometer, which is expressed in units of picosecond/nanometer/kilometer (ps/nm/km).

The dispersion experienced by each wavelength of light is also different, and is primarily controlled by a combination of the material dispersion, and the dispersion created by the actual profile of the waveguide, known as waveguide dispersion. The differential of the dispersion in relation to wavelength is known as the slope, or second order dispersion, and is in units of ps/nm². Optical fibers may be further characterized by their slope per unit length of 1 kilometer, which is expressed in units of picosecond/nanometer²/kilometer (ps/nm²/km).

Few mode fibers designed to have specific characteristics in a mode other than the fundamental mode are also known as high order mode (HOM) fibers. HOM fibers are particularly useful for compensating chromatic dispersion due to the large amount of negative dispersion which can be achieved for a signal traversing certain a selected high order mode in a fiber with a specially designed profile. Additionally, HOM fibers may compensate for much or all of the slope of a given transmission fiber.

Single mode fibers (SMF) designed as dispersion compensating fibers (DCF) are well known in the art, and typically exhibit dispersion on the order of −80 ps/nm/km. Unfortunately, single mode DCF exhibits a small effective area (A_{eff}) which limits the amount of power which may traverse the fiber without experiencing non-linear effects. New single mode fibers that compensate for both dispersion and slope have been recently marketed, however these suffer from an even smaller A_{eff}.

U.S. Pat. No. 6,339,665 assigned to the current assignee of this application describes a dispersion compensation device using at least two chromatic dispersion compensation fibers to compensate for chromatic dispersion present in an optical communication system. For at least one of the dispersion compensating fibers, the dispersion compensation is achieved using a high order spatial mode. Typical HOM compensating fibers exhibits both large negative dispersion and large negative slope, and the second fiber thus acts as a trim fiber to fine-tune the dispersion and slope compensation.

While these techniques can compensate for both dispersion and some or all of the slope, they are limited in that they need to be designed to precisely match the fiber span which they are compensating. Over the years different manufacturers have produced various types of optical transmission fibers each with their own dispersion and slopes. Furthermore, the actual amount of dispersion exhibited by a signal traveling through an optical transmission fiber span is dependent on the length of the span. The length of the span is often not precisely known, nor is the constituency of the actual fiber in the span known. As a result, a system supplier desiring to install dispersion compensation devices at a site, must arrive with an inventory of possible dispersion compensating fibers.

U.S. Pat. No. 5,218,662 describes a method and system to compensate end-to end optical dispersion for a fiber-optic cable having a plurality of predetermined compensation sites to within a predetermined dispersion limit using a predetermined dispersion compensation increment. However no provision is made for compensating for the dispersion slope.

U.S. Pat. No. 5,608,562 describes an optical communication system using adjustable dispersion compensating fibers to compensate for dispersion in transmission fibers. However here too, no provision is made for compensating for dispersion slope. Furthermore, the use of dispersion compensating fibers is expensive, and attaching a dispersion compensating fiber to a switch oftentimes causes undesirable increased attenuation losses. The amount of these losses is determined primarily by the loss inherent in the dispersion compensating fiber and the large splice loss, typically 0.2 db per splice or 0.6 dB for connectors, caused by the mode mismatch between standard fiber and the dispersion compensating fiber.

U.S. Pat. No. 6,259,845 describes a dispersion compensating module including segments of optical fibers of varying length, some of which have positive dispersion and some of which have a negative dispersion. However here too, no provision is made for compensating for dispersion slope. Furthermore, the use of dispersion compensating fibers is expensive, and attaching a dispersion compensating fiber to a switch oftentimes causes undesirable increased attenuation losses. The amount of these losses is determined primarily by the loss inherent in the dispersion compensating fiber and the large splice loss, typically 0.2 db per splice, or 0.6 dB for connectors, caused by the mode mismatch between standard single mode fiber and the dispersion compensating fiber.

Thus there is a long felt need for configurable dispersion management device, which can compensate for both dispersion and slope of an optical transmission system, and which does not exhibit large losses from mode mismatch.

### SUMMARY OF THE INVENTION

Accordingly, it is a principal object of the present invention to overcome the disadvantages of prior art methods of dispersion and slope compensation. This is provided in the present invention by the use of a configurable dispersion and slope compensating device which is provided with a mode transformer in serial communication with a high order mode fiber, an optical switching means and at least one trim fiber which is switched into the optical path as required so that at least 80% of the slope of an optical communication span are compensated. In a preferred embodiment, at least 80% of the dispersion of an optical communication span is compensated as well. In another preferred embodiment the configurable dispersion compensating device further comprises a fixed trim fiber in serial communication with the high order mode fiber. In another preferred embodiment the configurable dispersion compensating device further comprises at least one attenuator which exhibits a nominal loss similar to that of one of the trim fibers. Further preferably the switching means operates to place the at least one attenuator in the optical path whenever its matching trim fiber is not being utilized. In one embodiment the mode transformer comprises a transverse mode transformer.

In an exemplary embodiment the trim fiber comprises single mode fiber. In another embodiment the trim fiber comprises slope correcting fiber. Preferably the switching means comprises remotely controllable switches, and further preferably the remotely controllable switches are actively controlled from a network management station. In one embodiment the switching means comprise jumpers or patch cords to be set by a technician.

The invention also provides for a method of configurable dispersion and slope compensation for an optical span comprising the steps of supplying at least one high order mode fiber and at least one mode transformer in serial optical communication therewith, supplying an optical switching means and at least one trim fiber which is switchably connected by the optical switching means into optical communication with the optical communication line, whereby at least 80% of the slope is compensatable at each span. In a preferred embodiment at least 80% of the dispersion is compensatable at each span.

In another preferred embodiment the method also comprises supplying a fixed trim fiber. In another preferred embodiment at least one attenuator is supplied, further preferably the attenuator is connected by the switching means so that when the trim fiber is not in optical communication with the link, the associated attenuator is connected and the same amount of insertion loss is experienced.

In another embodiment the mode transformer is a transverse mode transformer comprising a phase element. In a preferred embodiment, the trim fiber comprises a single mode fiber. In another preferred embodiment the trim fiber comprises a slope correcting fiber, which has a relatively large effective area.

In another embodiment, the switching means comprises remotely controllable optical switches, which still further preferably are remotely controlled from a network management station. In another embodiment the switching means comprises jumpers or patch cords.

Additional features and advantages of the invention will become apparent from the following drawings and description.

### BRIEF DESCRIPTION OF THE DRAWINGS

The above and further advantages of this invention may be better understood by referring to the following description taken in conjunction with the accompanying drawings in which like numerals designate corresponding elements or sections throughout, and in which:

FIG. 1 illustrates a prior art communication system;

FIG. 2 illustrates a graph of dispersion vs. distance of the system of FIG. 1;

FIG. 3 illustrates a graph of slope vs. distance of the system of FIG. 1;

FIG. 4 illustrates a graph of dispersion vs. distance of another embodiment of the system of FIG. 1;

FIG. 5 illustrates a graph of allowable dispersion and dispersion slope;

FIG. 6 illustrates an embodiment of a configurable dispersion compensating device;

FIG. 7 illustrates an embodiment of a dispersion compensating device comprising a high order mode fiber;

FIG. 8 illustrates an embodiment of a configurable dispersion compensating device according to a first embodiment of the invention;

FIG. 9 illustrates an embodiment of a configurable dispersion compensating device according to a second embodiment of the invention;

FIG. 10 illustrates an embodiment of a configurable dispersion compensating device according to a third embodiment of the invention;

FIG. 11 illustrates a graph of dispersion vs. slope according to a first embodiment of the invention;

FIG. 12 illustrates a graph of residual dispersion vs. dynamic range according to a first embodiment of the invention, and

FIG. 13 illustrates a plot of residual dispersion and slope accuracy as a function of granularity.

### DETAILED DESCRIPTION OF THE PREFERRED EMBODIMENTS

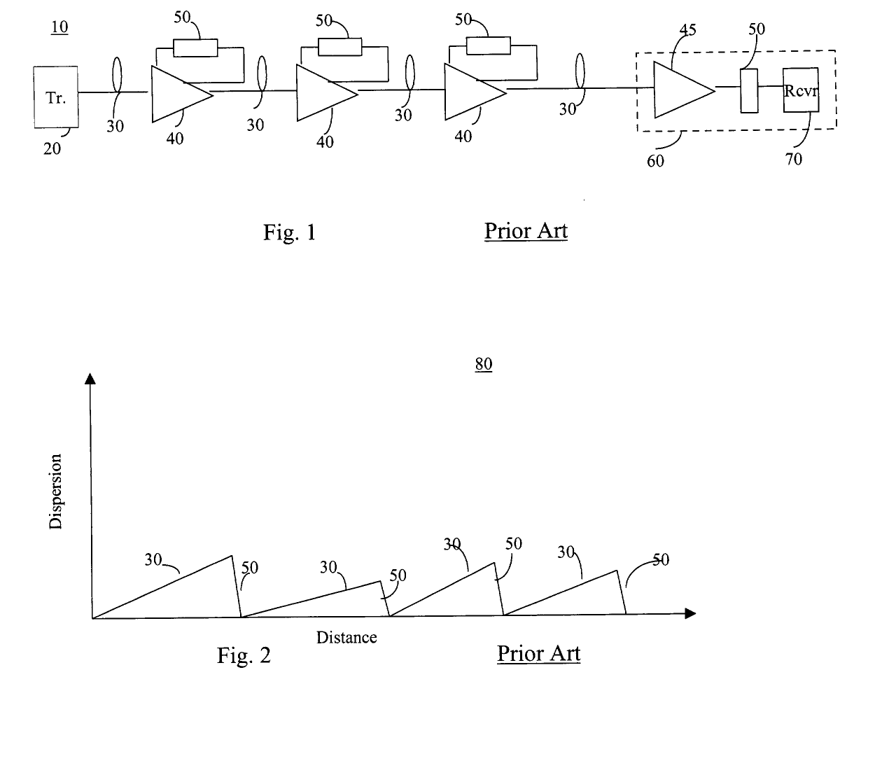

FIG. 1 shows a high level block diagram of a prior art system 10 comprising transmitter 20, transmission span 30, optical amplifier 40, optical pre-amplifier 45, dispersion compensation device (DCD) 50, receiver module 60 and receiving unit 70. Transmitter 20 is optically connected to one end of first transmission span 30, and first amplifier 40 is connected to the other end. DCD 50 is connected between stages of amplifier 40. The output of first amplifier 40 is connected to one end of second transmission span 30, and the second end of second transmission span 30 is connected to the input of second amplifier 40. The sequence is repeated over multiple transmission spans, until the final transmission span 30 is connected to the input of receiver module 60. The input of receiver module 60 comprises the input of pre-amplifier 44, and DCD 50 is connected at the output of pre-amplifier 40. The output of DCD 50 is connected to the input of receiver 70.

In operation of system 10, amplifier 40 typically comprises a multiple stage erbium doped amplifier, and functions to optically amplify the signal which has been attenuated by the previous transmission span 30. DCD 50 is connected between stages of the amplifier 40, and acts to compensate for the chromatic dispersion imparted by transmission span 30. System 10 comprises multiple transmission spans 30, with an amplifier 40 and a DCD 50 connected at the end of each transmission span. Receiver module 60 is connected to the last transmission span, and acts to convert the optical signal to an electrical signal. Receiver module 60 comprises an optical pre-amplifier 45, which in an exemplary embodiment comprises only the pre-amplifier stages of an optical amplifier. The output of pre-amplifier 45 is connected to DCD 50 which operates to compensate for the dispersion experience in final transmission span 30. The output of DCD 50 is connected to the input of receiver 70 which operates to convert the optical signal to an electrical signal. Receiver 60 may be a final receiver for the data or, as part of a longer length system, it may be part of an optical electrical optical regeneration station.

FIG. 2 shows a graph 80 of the dispersion experienced by an optical signal as it traverses the system 10 of FIG. 1. The x-axis indicates distance in the system from the transmitter, and the y-axis indicates accumulated dispersion. Increasing dispersion is experienced by the signal as it traverses transmission span 30, and negative dispersion is experienced by the signal as it traverses DCD 50. The graph shows complete dispersion compensation by each DCD 50, with a nominally zero dispersion at the beginning of each transmission span 30. FIG. 2 illustrates the dispersion of the signal at a specific wavelength, typically that of the middle of the transmission band. In an exemplary embodiment the signal is fully compensated for at 1545 nm, the center of the “C” band.

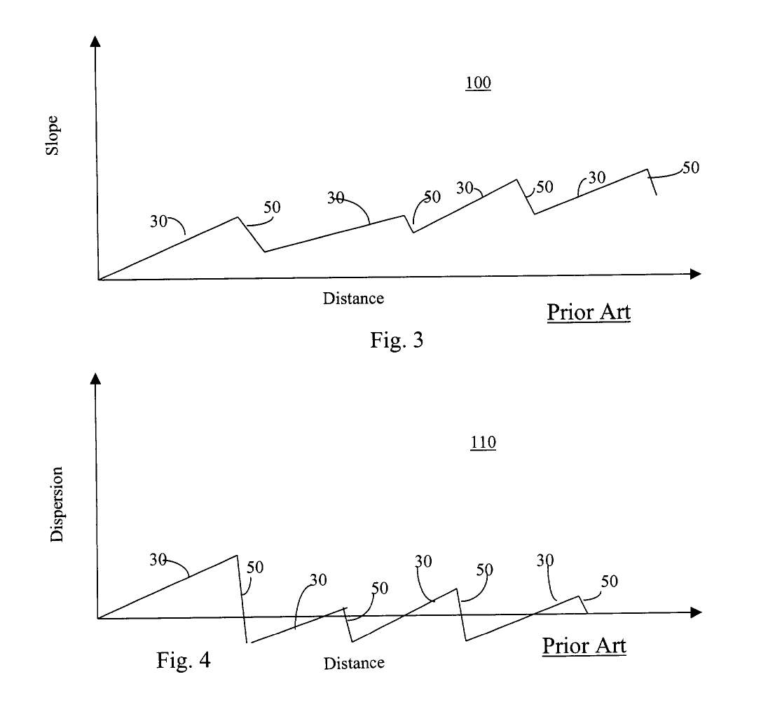

FIG. 3 shows a graph 100 of the slope experienced by an optical signal as it transverses the system 10 of FIG. 1. The x-axis indicates distance in the system from the transmitter, and the y-axis indicates accumulated slope. Increasing slope is experienced by the signal as it transverses transmission span 30, and only some of the slope is compensated for by DCD 50. Commercially available dispersion and partial slope compensating fibers are available, however only up to 65% of the slope of a non-zero shifted dispersion fiber is compensated. The slope of the second transmission fiber 30 does not match that of the first transmission fiber, as it consists of a different type of fiber. Each span has only part of its slope compensated for by the DCD 50, with the total dispersion slope increasing as a function of distance. FIG. 3 shows DCD 50 partially compensating for the slope of the transmission fiber 30. In another embodiment, DCD 50 does not compensate for the slope of transmission fiber 30, and the slope continues to increase over the transmission distance. Thus the ends of the band are not fully compensated for.

FIG. 4 shows a graph 110 of the dispersion experienced by an optical signal as it traverses the system 10 of FIG. 1 utilizing another method known to the prior art, and described in U.S. Pat. No. 5,218,662. The x-axis indicates distance in the system from the transmitter, and the y-axis indicates accumulated dispersion. Increasing dispersion is experienced by the signal as it traverses transmission span 30, and is alternatively over compensated or under compensated by each DCD 50. At the receiver the signal is nominally dispersion compensated within a predetermined tolerance level. No attempt is made to compensate for the slope, and the accumulated slope of the signal is similar to that discussed in relation to FIG. 3.

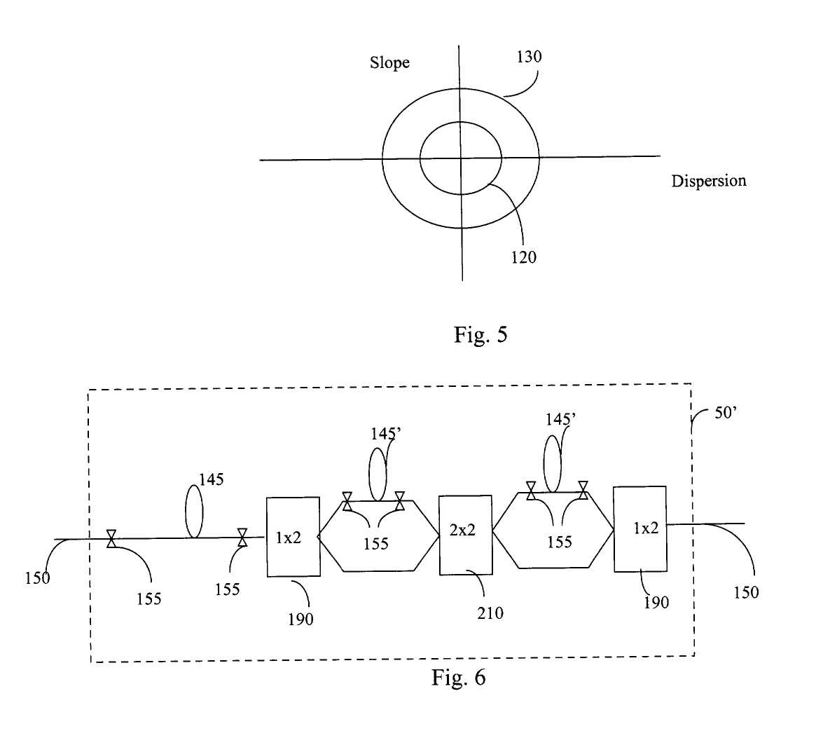

FIG. 5 shows a graph of allowable dispersion and slope of the optical signal. The x-axis indicates total accumulated dispersion, and the y-axis indicates total accumulated slope. Each type of fiber imparts a different combination of slope and dispersion to a signal at a specific wavelength. Over a small range of wavelengths, such as over the “C” band of 1525-1565 nm the slope is constant, and thus the dispersion curve may be approximated by a straight line. The area bound by curve 120 represents the acceptable limits of dispersion and slope for the receiver 70. Signals appearing with dispersion and slope characteristics outside of curve 120 will cause errors in the reception of the signal. Curve 130 represents the acceptable limits of dispersion and slope acceptable at each amplifier 40. Signals appearing with dispersion and slope characteristics outside of curve 130 will cause errors in the ultimate reception of the signal. It is to be noted that the area bound by curve 130 is greater than that bound by curve 120, since the dispersion and slope tolerance at the receiver 70 is much smaller than the tolerance at the amplifiers 40.

FIG. 6 illustrates a configurable DCD 50′ comprising single mode fiber (SMF) input 150, splices 155, 1×2 switches 190, 2×2 switch 210, and dispersion compensating fiber (DCF) 145, 145′ and 145″. DCF 145 compensates for the majority of the dispersion of the transmission span 30 and in an exemplary embodiment comprises a long length of DCF designed with a negative dispersion of about −80 ps/nm/km, and a relatively small A_{eff} of about 20 μm. DCFs 145′ are each considered trim fibers, capable of compensating for different lengths of transmission fiber in span 30. In an exemplary embodiment, the trim fibers 145′ are a multiple of a basic unit length, known as the granularity. The dispersion granularity of configurable DCD 50′ is given by the equation

Granularity=D_{compensating}*Unit lengthₜᵣᵢₘ/D_{transmission span}

where D_{compensating} represents the absolute value of the characteristic dispersion per unit length of the trim DCF, and D_{transmission span} represents the characteristic dispersion of the connected transmission span. The Unit length represents the basic unit of length of the configurable section of DCD 50′, in an exemplary embodiment the length of first DCF 145′. Second DCF 145′ is thus a multiple of the length of first DCF 145′, in an exemplary embodiment twice the length. Additional switches 210 and lengths of DCF 145′ can be added to expand DCD 50′ so as to cover a larger dynamic range. The dynamic range is the range of lengths of transmission fiber 30 that can be compensated for by the device. It is important to emphasize that DCF does not fully compensate for the slope of the transmission span.

While the invention will be described utilizing an optical switch, this is not meant to be limiting in any way, and is to include other methods of connecting various optical fibers such as patch cords, jumpers, splices and circulators.

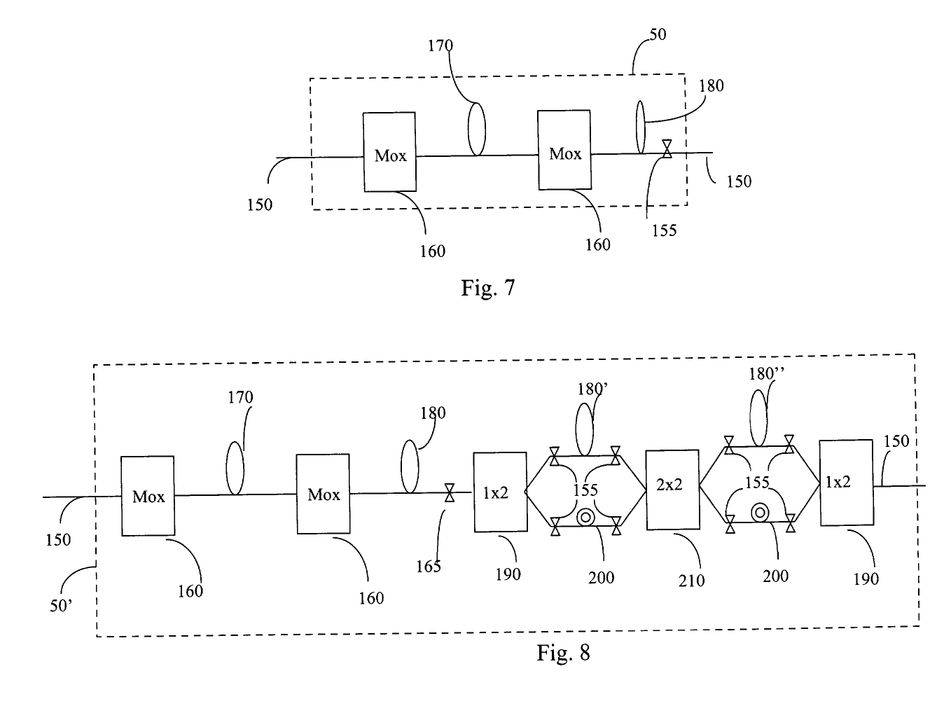

FIG. 7 illustrates a high level block diagram of a non-configurable high order mode based DCD 50 comprising SMF input and output 150, mode transformer 160, HOM dispersion compensating fiber 170 and optional trim fiber 180 and splice 155, in a manner further described in U.S. Pat. No. 6,339,665 whose contents are incorporated herein by reference. SMF 150 is connected to the input of first mode transformer 160, and the output of first mode transformer 160 is connected to one end of HOM dispersion compensating fiber 170. The second end of HOM dispersion compensating fiber 170 is connected the input of second mode transformer 160, and the output of second mode transformer 160 is connected to one end of optional trim fiber 180. The second end of optional trim fiber 180 is connected at splice 155 to the output of DCD 50 through output SMF 150.

In operation input SMF 150 carries the optical signal which has experienced dispersion caused by the associated transmission span (not shown) in the fundamental mode LP₀₁. Mode transformer 160 changes the mode of the optical signal from the LP₀₁ mode substantially to a single high order mode. In an exemplary embodiment the high order mode is the LP₀₂ mode. The output of mode transformer 160 is coupled to the input of high order mode fiber 170, which acts to impart negative dispersion and slope to the optical signal. High order mode fiber 170 exhibits strong negative dispersion, typically on the order of −200 to −600 ps/nm/km, and thus only a short length of high order mode fiber is required in order to compensate for the dispersion of span 30. The output of high order mode fiber 170 is connected to the input of second mode transformer 160, which converts the optical signal from the high order mode to the fundamental mode, LP₀₁. The high order mode fiber in some cases over-compensates for both dispersion and slope, and the output of second mode transformer 160 is connected to optional trim fiber 180, which in one embodiment comprises a predetermined length of SMF, with the appropriate dispersion and slope to complete the compensation of the signal. In an exemplary embodiment, trimming fiber 180 comprises a length of SMF such as SMF-28 ® made by Corning, Inc. which exhibits relatively large positive dispersion at 1550 nm, with relatively little slope. In this exemplary embodiment the losses from splice 155 are negligible. In another embodiment trim fiber 180 comprises a slope correcting fiber of the type described in copending U.S. Provisional Application Ser. No. 60/364,082 filed Mar. 15, 2002 entitled “Trim Fiber for High Order Mode Applications” whose contents are incorporated herein by reference, which exhibits a large effective area, on the order of that of single mode transmission fiber, and thus non-linear effects are minimized. The loss experienced by the optical signal in DCD 50 is primarily due to the mode transformer losses, as well as losses attributable to the length of HOM fiber 170 and trim fiber 180. In an exemplary embodiment mode transformers 160 comprise transverse mode transformers of the type described in U.S. Pat. No. 6,404,951. In another embodiment, mode transformers 160 comprises a long period grating, or any other mode transformer known to those skilled in the art.

FIG. 8 illustrates a first embodiment of an inventive DCD 50′ comprising SMF 150, mode transformer 160, high order mode dispersion compensating fiber 170, splices 155, optical 1×2 switch 190, optical attenuator 200, optical 2×2 switch 210, and trim fibers 180, 180′ and 180″. Input SMF 150 is connected to the input of first mode transformer 160, and the output of first mode transformer 160 is connected to one end of HOM 170. The second end of HOM 170 is connected to the input of second mode transformer 160, and the output of second mode transformer 160 is connected to one end of optional trim fiber 180. The second end of optional trim fiber 180 is connected through splice 155 to the input of first optical 1×2 switch 190. In an embodiment not requiring optional trim fiber 180, the output of second mode transformer 160 is connected directly to the input of optical 1×2 switch 190. One output of first optical 1×2 switch 190 is connected to one end of trim fiber 180′, and the second end of trim fiber 180′ is connected to one input of optical 2×2 switch 210. The second output of first optical 1×2 switch 190 is connected one end of first optical attenuator 200, and the second end of first optical attenuator 200 is connected to the second input of optical 2×2 switch 210. One output of optical 2×2 switch 210 is connected to one end of trim fiber 180″, and the second end of trim fiber 180″ is connected to one input of second optical 1×2 switch 190. The second output of optical 2×2 switch 210 is connected one end of second optical attenuator 200, and the second end of second optical attenuator 200 is connected to the second input of second optical 1×2 switch 190. The output of second optical 1×2 switch 190 is connected to the output of configurable DCD 50′ by output SMF 150.

Trimming fiber 180 is optional, and is only required to correct for any overcompensation caused by high order mode fiber 170. Trim fibers 180′ and 180″ are pre-selected to achieve both the desired granularity of the dispersion and slope, as well as the desired dynamic range. In one embodiment, each trim fiber 180′ and 180″ is a multiple of basic unit length as described above in relation to FIG. 6. In a preferred embodiment, the length of trim fiber 180′ is the amount of trim fiber able to compensate for 1 unit of granularity of the transmission fiber 30. In a further preferred embodiment trim fiber 180″ is a multiple of the length of trim fiber 180′. In one embodiment trim fiber 180″ is twice the length of trim fiber 180′.

In operation, high order mode fiber 170 operates to compensate for the dispersion and slope imparted by span 30, and optional trim fiber 180 acts to trim the compensation of both dispersion and slope to nominal negative values. The actual characteristics and length of span 30 are not precisely known to the operator, and thus the actual dispersion and slope may be either over compensated or under compensated for. By operating switches 190 and 210 trim fibers 180′ and 180″ are added to the system. Trim fiber 180′ adds one unit of granularity to the system, adding dispersion and slope based on the characteristics of the trim fiber. In a first exemplary embodiment trim fiber 180′ and 180″ comprise SMF fiber, exhibiting positive dispersion of approximately 17 ps/nm/km with minimal slope of about 0.06 ps/nm²/km. In the event that the combination of HOM fiber and optional trim fiber 180 introduce more negative dispersion than is desired, first optical 1×2 switch 190 is operated to insert trim fiber 180′ into the optical path. In the event that even less negative dispersion is desired, optical 2×2 switch 210 is operated to insert trim fiber 180″ into the optical path, which in an exemplary embodiment has twice the unit length of trim fiber 180′, and thus adds two units of positive dispersion and minimal slope to the system. Both trim fibers 180 and 180″ may be placed into the optical path, thus introducing the least amount of negative dispersion. Optional attenuators 200, 200′ act to maintain a fixed loss of the device irrespective of the position of first optical 1×2 switch 190 and optical 2×2 switch 210 by supplying a loss approximately equal to that of the associated trim fiber. Second optical 1×2 switch 190 is operated in concert with optical 2×2 switch 210 to maintain the appropriate optical path.

A unique feature of this first exemplary embodiment of the invention is the use of positive trimming with standard single mode fiber, which can be spliced to optical switches with minimal loss. In an exemplary embodiment DCD 50′ is designed to compensate for between 72.5 km and 87.5 km of non-zero dispersion shifted transmission fiber exhibiting typical dispersion of 3.74 ps/nm/km and slope of 0.085 ps/nm² km at the center of the “C” band, 1545 nm, such as the enhanced LEAF® product sold by Corning Inc.. HOM 170 comprises a fiber designed to impart −327 ps/nm of dispersion and −6.9 ps/nm² of slope, and optional trim fiber 180 is not utilized. In this embodiment trim fiber 180′ comprises 2.3 km of SMF, and trim fiber 180″ comprises 4.6 km of SMF. It should be emphasized that the use of DCF, which would advantageously be utilized to add additional dispersion compensation in place of the SMF trim fibers 180, 180′ and 180″ would add additional losses, and DCD 50′ would be subject to non-linear effects due the DCF's small effective area. The layout of the device as shown in FIG. 8 thus allows for a single configurable DCD which can compensate for a range of transmission span lengths. The accuracy of dispersion and slope achievable in each of its states is determined by the granularity needed as well as by the overall dynamic range as will be discussed. The switches 190 and 210 may be manually controlled, or remotely controlled to maintain overall system dispersion in a fixed range in a manner known to those skilled in the art. It is to be understood that additional trimming fibers may be added with additional switches without exceeding the scope of the invention.

In a second exemplary embodiment, trim fibers 180′ and 180″ are of the type described in co-pending U.S. Provisional Application Ser. No. 60/364,082 filed Mar. 15, 2002 entitled Trim Fiber for High Order Mode Applications, which exhibit large positive slope and negative dispersion with a large effective area. Adding trim fiber 180′ and/or trim fiber 180′ will act to greatly increase the positive slope exhibited by DCD 50′, while increasing the negative dispersion of DCD 50′, and the large effective area minimizes any non-linear effects.

FIG. 9 illustrates a second embodiment of an inventive configurable DCD 50′ comprising SMF 150, 1×2 optical switch 190, mode transformers 160, high order mode fibers 170 and 170′, splices 155, 2×2 optical switch 210, trim fibers 180, 180′, 180″ and attenuators 200 and 200′. Input SMF 150 is connected to the input of first optical 1×2 switch 190. One output of first optical 1×2 switch 190 is connected to the input of first mode transformer 160, and the output of first mode transformer 160 is connected to one end of first HOM 170. The second end of first HOM 170 is connected to the input of second mode transformer 160, and the output of second mode transformer 160 is connected to one end of first optional trim fiber 180. The second end of first optional trim fiber 180 is connected through splice 155 to one input of first optical 2×2 switch 210.

The second output of first optical 1×2 switch 190 is connected to the input of third mode transformer 160, and the output of third mode transformer 160 is connected to one end of second HOM 170. The second end of second HOM 170 is connected to the input of fourth mode transformer 160, and the output of fourth mode transformer 160 is connected to one end of second optional trim fiber 180. The second end of second optional trim fiber 180 is connected through splice 155 to the second input of first optical 2×2 switch 210.

One output of first optical 2×2 switch 210 is connected to one end of trim fiber 180′, and the second end of trim fiber 180′ is connected to one input of second optical 2×2 switch 210. The second output of first optical 2×2 switch 210 is connected one end of first optical attenuator 200, and the second end of first optical attenuator 200 is connected to the second input of second optical 2×2 switch 210. One output of second optical 2×2 switch 210 is connected to one end of trim fiber 180″, and the second end of trim fiber 180″ is connected to one input of second optical 1×2 switch 190. The second output of second optical 2×2 switch 210 is connected one end of second optical attenuator 200, and the second end of second optical attenuator 200 is connected to the second input of second optical 1×2 switch 190. The output of second optical 1×2 switch 190 is connected to the output of configurable dispersion compensating device 50′ by output SMF 150.

In operation DCD 50′ of FIG. 9 operates similarly to that of FIG. 8 with the exception of the ability to switch between first HOM fiber 170, with its optional first trim fiber 180 and second HOM fiber 170 and its optional second trim fiber 180 through the operation of first 1×2 optical switch 190 and first 2×2 optical switch 210. Each of first HOM 170 and second HOM 170 are selected to compensate for different types of transmission fibers, each of which may exhibit a different combination of dispersion and slope. Thus, one device can compensate for a range of fibers with varying dispersion and slopes and with differing span lengths by alternatively switching first and second HOM fibers 170 and the combination of fibers 180′ and 180″. This allows for a single device, with a dynamic range established by the lengths of 180′ and 180″ to function with a variety of transmission fibers.

In another embodiment of DCD 50′ of FIG. 9, first HOM fiber 170 is designed to compensate a transmission fiber of a specific length, and with a combination of trim fibers 180′, 180″ cover a larger dynamic range. Second HOM fiber 170 is designed to expand the dynamic range by compensating for fibers of a length that can not be compensated by utilizing a combination of first HOM fiber 170 and the trim fibers 180′ and 180″. Utilizing second HOM fiber 170 in combination with trim fibers 180′ and 180″ thus allows for a larger dynamic range for the device.

It is to be understood that in all embodiments, additional trimming fibers may be added with additional switches. In addition, additional high order mode fibers may be added in parallel to enable the single device to compensate for an even broader range of transmission fibers without exceeding the scope of the invention.

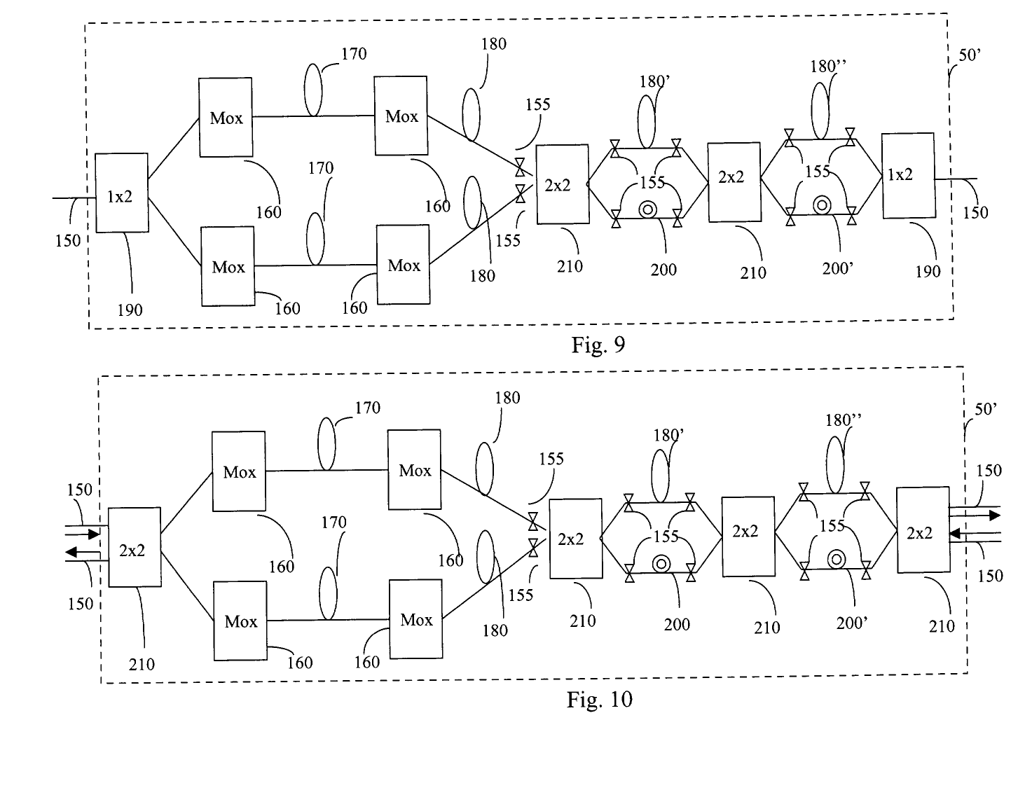

FIG. 10 illustrates a third embodiment of an inventive configurable dispersion compensating device 50′ comprising SMF 150, mode transformers 160, high order mode fibers 170, splices 155, 2×2 optical switch 210, trim fibers 180, 180′, 180″ and attenuators 200 and 200′. First input SMF 150 is connected to a first port of first optical 2×2 switch 210 and first output SMF 150 is connected to a second port of first optical 2×2 switch 210. A third port of first optical 2×2 switch 210 is connected to a first port of first bi-directional mode transformer 160, and the second port of first bi-directional mode transformer 160 is connected to one end of first HOM 170. The second end of first HOM 170 is connected to a first port of second bidirectional mode transformer 160, and the second port of second bi-directional mode transformer 160 is connected to one end of first optional trim fiber 180. The second end of first optional trim fiber 180 is connected through splice 155 to one port of second optical 2×2 switch 210.

The fourth port of first optical 2×2 switch 210 is connected to one port of third bi-directional mode transformer 160, and the second port of third bi-directional mode transformer 160 is connected to one end of second HOM 170. The second end of second HOM 170 is connected to a first port of fourth mode transformer 160, and the second port of fourth mode transformer 160 is connected to one end of second optional trim fiber 180. The second end of second optional trim fiber 180 is connected through splice 155 to a second port of second optical 2×2 switch 210.

A third port of second optical 2×2 switch 210 is connected to one end of trim fiber 180′, and the second end of trim fiber 180′ is connected to a first port of third optical 2×2 switch 210. The fourth port of second optical 2×2 switch 210 is connected one end of first optical attenuator 200, and the second end of first optical attenuator 200 is connected to a second port of third optical 2×2 switch 210. A third port of third optical 2×2 switch 210 is connected to one end of trim fiber 180″, and the second end of trim fiber 180″ is connected to a first port of fourth optical 2×2 switch 210. The fourth port of third optical 2×2 switch 210 is connected one end of second optical attenuator 200, and the second end of second optical attenuator 200 is connected to a second port of fourth optical 2×2 switch 210. The third port of fourth optical 2×2 switch 210 acts as the output and is connected to the output of configurable dispersion compensating device 50′ by second output SMF 150. The fourth port of fourth optical 2×2 switch 210 acts as the second input to the device and is connected to the second input SMF 150.

In operation DCD 50 of FIG. 10 operates similarly to that of FIG. 9 with the exception of the ability to act in a bi-directional manner, in which the optical signal may proceed in either direction through the device, or in both directions simultaneously utilizing different paths. In this embodiment optical 2×2 switches 210 enable operation of paths in each direction. This provides additional cost savings by fully utilizing the paths in the device. In an exemplary embodiment one path may be the primary path, with the opposing direction representing the protection path. The transmission span 30 in one path is fully compensated by DCD 50, while the second path may not be fully compensated. In a large network, such as one illustrated in FIG. 1, any under or over compensation is balanced out over the system at alternating DCD's, provided that the characteristics of residual dispersion do not exceed the borders described in relation to FIG. 5.

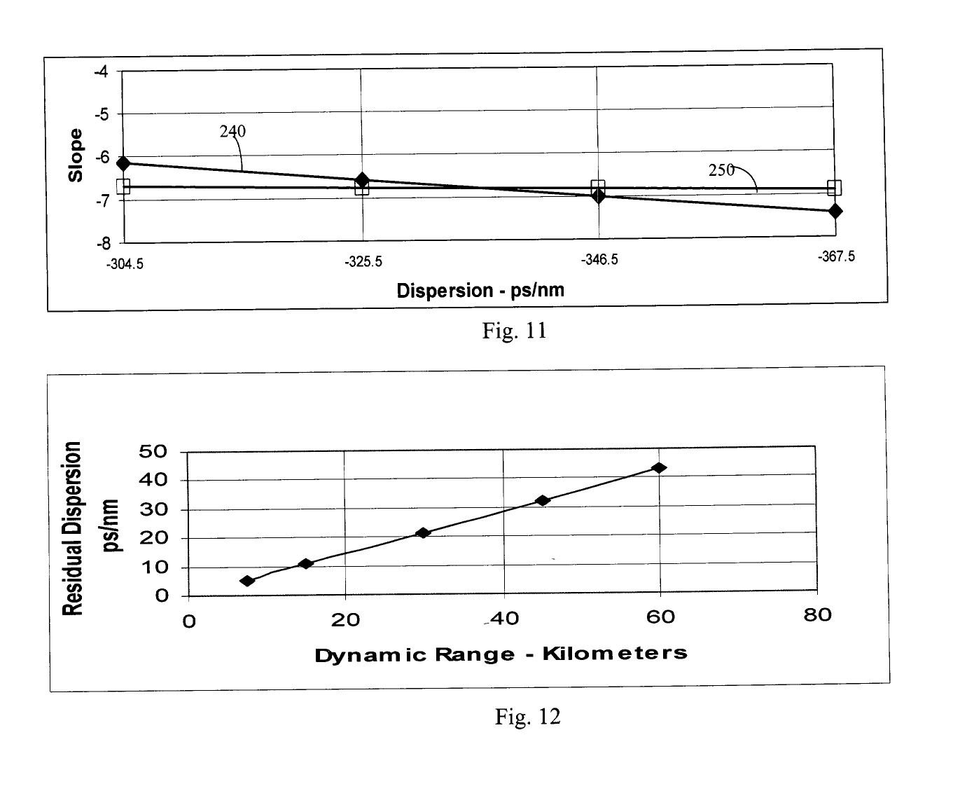

FIG. 11 illustrates the effect of the first exemplary embodiment of the inventive DCD 50′ of FIG. 8 on dispersion and slope. The x-axis represents dispersion in ps/nm and the y-axis represents slope in ps/nm². The device is designed for applications with a transmission fiber 30 comprising a non-zero dispersion shifted fiber with the characteristics previously mentioned, with a granularity of 5 km, and a target of an average of 80 km per span. HOM fiber 170 is designed to fully compensate for the dispersion of the longest length of transmission fiber which may be attached. In an exemplary embodiment approximately 0.875 kilometers of HOM fiber 170 exhibiting −374 ps/nm/km and slope of −7.9 ps/nm²/km is utilized. Any deviation from the nominal value is compensated for by optional trim fiber 180. Trim fibers 180′ and 180″ comprise lengths of SMF fiber as mentioned above and exhibit dispersion of 16.2 ps/nm·km and slope of 0.057 ps/nm²·km at 1545 nm, the center of the C band. Line 240 represents the dispersion and slope of the transmission fiber 30 for the various lengths for which the device is designed, and line 250 represents the net overall compensation of the device of FIG. 8 in each of its different configuration. The various lengths of transmission fiber that can be compensated for by the device varies from 72.5 km to 87.5 km in 5 km steps. HOM fiber 170, with optional trim fiber 180, is designed to match the total dispersion of the maximum length, in this embodiment 87.5 km. Shorter lengths are compensated for by switching in sections of trim fiber 180′, 180″ as discussed above. HOM fiber 170 is designed so that the slope of the device crosses the slope of the transmission fibers in the middle of the range. At each DCD 50′ the slope is either under compensated or over compensated for. However the net overall dispersion compensation is within the tolerance of the system, as discussed in relation to FIG. 5 above. Since the device generates under and over slope compensation over the nominal range of span length, the total accumulated slope mismatch is much smaller than the per span slope mismatch. Installed in a system, such as that of FIG. 1, any overcompensation of the slope in one span, will typically by matched by an under compensation of the slope in the next span, as the average length of the spans in the link tend to balance out to the design mid point.

It is to be understood that the smaller the granularity, the smaller will be the residual dispersion and the dispersion slope mismatch after each DCD 50′. FIG. 12 illustrates residual dispersion, where the x-axis represents the granularity in kilometers, and the y-axis represents the maximum residual dispersion at the edges of the C band in ps/nm. The dispersion matching is best when the granularity is the smallest providing the minimum residual dispersion and highest percentage of slope compensation. Furthermore, increasing the granularity has a cost in terms of the insertion loss of the device, as the length of trim fiber increases. It is to be understood that the smaller the granularity, the smaller the dynamic range, and the lower the insertion loss.

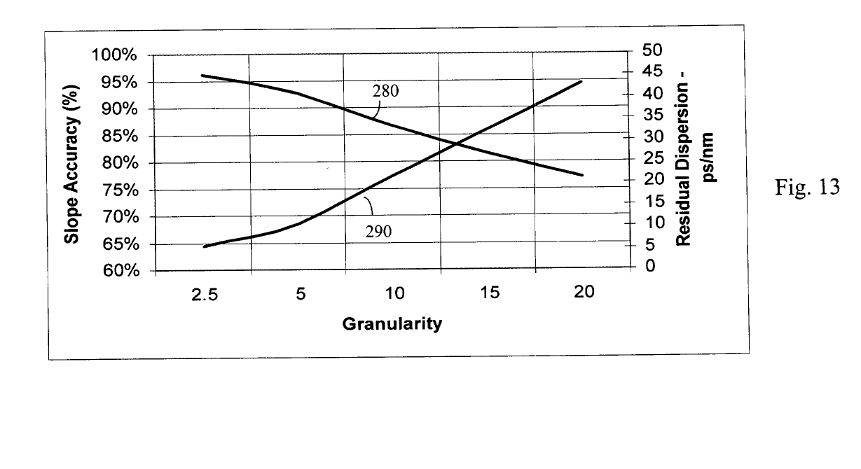

FIG. 13 illustrates a plot of slope mismatch, and its equivalent in terms of maximum residual dispersion. The y-axes represent residual dispersion in ps/nm and slope accuracy in percentage respectively, while the x-axis represents granularity in kilometers. Curve 280 represents the slope accuracy in percentage, and curve 290 represents the residual dispersion in ps/nm. The greater the granularity the larger the dynamic range, however the residual dispersion increases. Still, in the range of granularity of 15 km, which for the first exemplary embodiment translates to a dynamic range of 45 km, less than +/−20% slope mismatch is readily achievable.

The above description has assumed that high order mode dispersion fiber 170 has a fixed amount of dispersion. However, in certain circumstance the dispersion of high order mode fiber 170 can be modified. Co-pending U.S. patent application Ser. No. 860,647 filed May 22, 2001 entitled “Method and System for Compensating for Chromatic Dispersion”, whose contents are incorporated by reference includes a means for modifying the temperature and thus the dispersion characteristics of high order mode fiber 170. This enables fine tuning of the dispersion around a coarse point which has been achieved up to the granularity of the device.

The above system has been described with switches 190 and 210, which may be manually operated or replaced with jumpers, patch cords, splices or circulators. The switches in one embodiment are manually adjustable, which is typically accomplished at the initial installation, however the switch settings may be further adjusted by a technician. In another embodiment the switches are actively controlled from a network management station in a manner known to those skilled in the art. This allows for reconfiguration of the device as may be required due to environmental or other factors. Switch settings may be changed on line by first rerouting active traffic to a protection path, and then resetting the switches as desired to the required settings.

Having described the invention with regard to certain specific embodiments thereof, it is to be understood that the description is not meant as a limitation, since further modifications may now suggest themselves to those skilled in the art, and it is intended to cover such modifications as fall within the scope of the appended claims.

We claim:

1. A configurable dispersion and slope compensating device which compensates for an optical communication span comprising;
at least one mode transformer in serial optical communication with a high order mode fiber;
optical switching means; and
at least one trim fiber switchably connected in series with said high order mode fiber;
whereby said configurable dispersion and slope compensating device compensates for at least 80% of the slope of the optical communication span.

2. The configurable dispersion and slope compensating device of claim 1 whereby said configurable dispersion and slope compensating device compensates for at least 80% of the dispersion of the optical communication span.

3. The configurable dispersion and slope compensating device of claim 1 further comprising a fixed trim fiber.

4. The configurable dispersion and slope compensating device of claim 1 further comprising at least one attenuator.

5. The configurable dispersion and slope compensating device of claim 4 wherein said at least one attenuator is switchably connected by said switching means and whereby said configurable dispersion compensating device exhibits a nominally fixed insertion loss.

6. The configurable dispersion and slope compensating device of claim 1 wherein said mode transformer is a transverse mode transformer.

7. The configurable dispersion and slope compensating device of claim 1 wherein said trim fiber comprises single mode fiber.

8. The configurable dispersion and slope compensating device of claim 1 wherein said trim fiber comprises slope correcting fiber.

9. The configurable dispersion and slope compensating device of claim 1 wherein said switching means comprises remotely controllable optical switches.

10. The configurable dispersion and slope compensating device of claim 8 wherein said remotely controllable optical switches are actively controlled from a network management station.

11. The configurable dispersion and slope compensating device of claim 1 wherein said switching means comprises jumpers or patch cords.

12. A method of configurable dispersion and slope compensation for an optical communication span comprising the steps of:
supplying at least one high order mode fiber;
supplying at least one mode transformer in serial optical communication with said high order mode fiber;
supplying optical switching means and at least one trim fiber connected by said switching means, and
switchably connecting said at least one trim fiber into optical communication with the optical communication link, whereby at least 80% of the slope of said optical communication span is compensated.

13. The method of claim 12 whereby at least 80% of the dispersion of said optical communication span is compensated.

14. The method of claim 12 further comprising the step of supplying a fixed trim fiber.

15. The method of claim 12 further comprising the step of supplying at least one attenuator.

16. The method of claim 15 wherein said at least one attenuator is switchably connected by said switching means thereby exhibiting a nominally fixed insertion loss.

17. The method of claim 12 wherein said mode transformer is a transverse mode transformer.

18. The method of claim 12 wherein said trim fiber comprises single mode fiber.

19. The method of claim 12 wherein said trim fiber comprises slope correcting fiber.

20. The method of claim 12 wherein said switching means comprises remotely controllable optical switches.

21. The method of claim 20 further comprising the step of remotely controlling said optical switches from a network management station.

22. The method of claim 12 wherein said switching means comprises jumpers or patch cords.

23. A configurable dispersion and slope compensating device which compensates for an optical communication span comprising;
a first mode transformer in serial optical communication with a first high order mode fiber;
a second mode transformer in serial optical communication with a second high order mode fiber;
optical switching means switchably connected either said first mode transformer and said first high order mode fiber or said second mode transformer and said second high order mode fiber into serial optical communication with the optical communication span; and
at least one trim fiber switchably connected in series with said connected high order mode fiber;
whereby said configurable dispersion and slope compensating device compensates for at least 80% of the slope of the optical communication span.

24. The configurable dispersion and slope compensating device of claim 23 whereby said configurable dispersion and slope compensating device compensates for at least 80% of the dispersion of the optical communication span.
